(19) United States
(12) Patent Application Publication
(10) Pub. No.: US 2014/0153175 A1
(43) Pub. Date: Jun. 5, 2014

(54) MOUNTING APPARATUS FOR KEYBOARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: LI-XIN LIU, Shenzhen (CN); HSIEN-PIN TSOU, New Taipei (TW); WEI-KUANG LIANG, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/949,189

(22) Filed: Jul. 23, 2013

(30) Foreign Application Priority Data
Nov. 30, 2012 (CN) 2012105022900

(51) Int. Cl. G06F 1/16

(52) U.S. Cl. CPC G06F 1/16
USPC 361/679.08; 248/346.04

(57) ABSTRACT

A mounting apparatus includes a base and a plurality of latch members. The base includes a recess portion and a frame connected to the recess portion. The recess portion is configured to receive a keyboard. The plurality of latch members is secured to the frame, and each of the plurality of latch members includes a latch portion and two resilient arms attached to the latch portion. The latch portion of each of the plurality of latch members is configured to engage with the keyboard so that the keyboard is installed on the base. The two resilient arms are resiliently deformed to disengage from the keyboard so that the keyboard can be easily detached from the base.

### BACKGROUND

1. Technical Field

The present disclosure relates to mounting apparatuses, and particularly to a mounting apparatus for a computer keyboard.

2. Description of Related Art

A typical personal computer includes a keyboard and a base. The keyboard may be attached to the base with screws. A tool, such as a screwdriver, may be used to fasten or unfasten the screws when the keyboard is assembled or disassembled. The assembly and disassembly of the keyboard is laborious and time-consuming. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a mounting apparatus and a keyboard.

FIG. 2 is an enlarged view of a circled portion II of FIG. 1.

FIG. 3 is similar to FIG. 1, but viewed from another aspect.

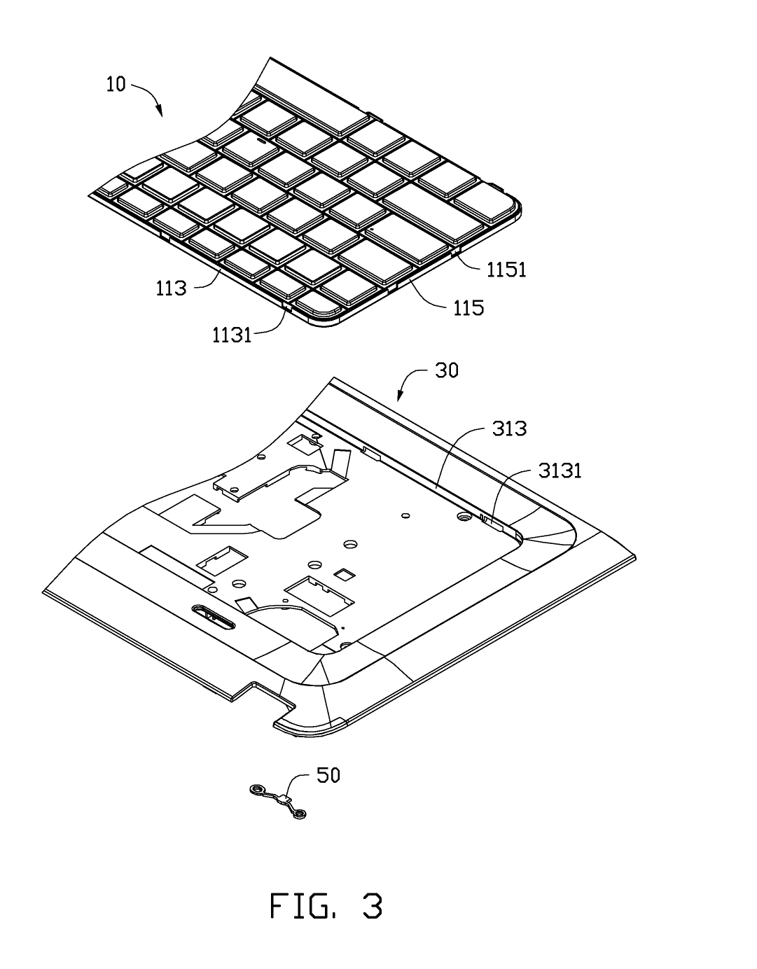

FIG. 4 is an exploded, isometric view of a base and a latch member of FIG. 1.

FIG. 5 is an assembled view of the mounting apparatus and the keyboard of FIG. 1.

FIG. 6 is a cutaway, cross-sectional view of the mounting board and the keyboard of FIG. 4, taken along the line VI-VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

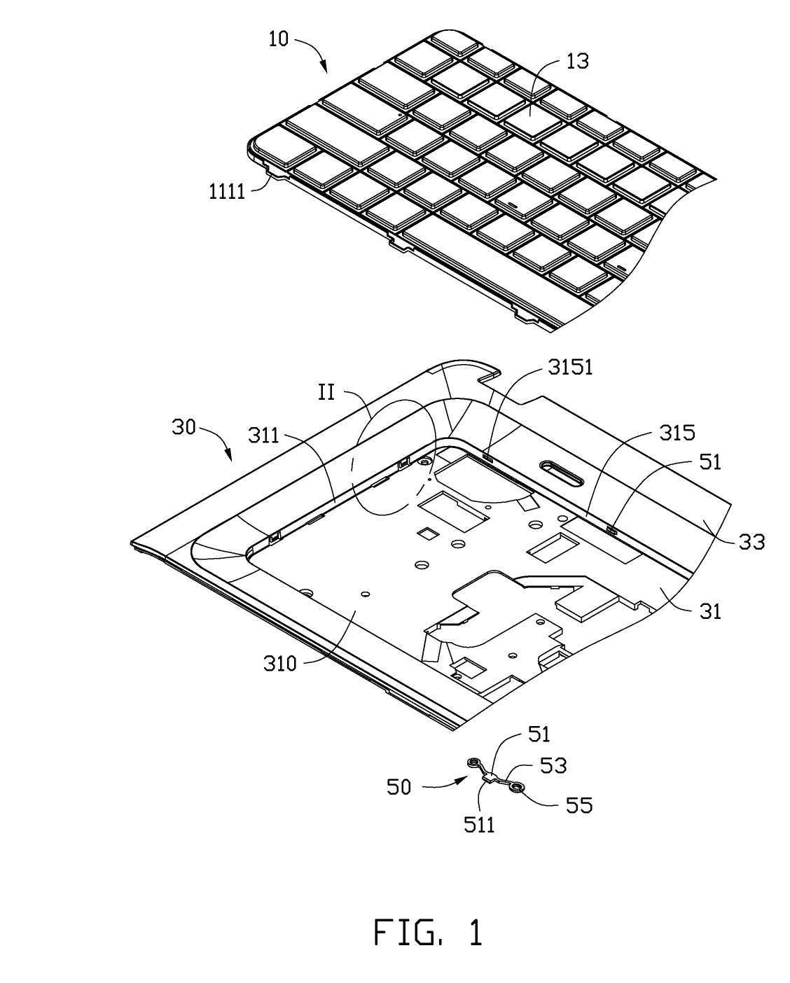

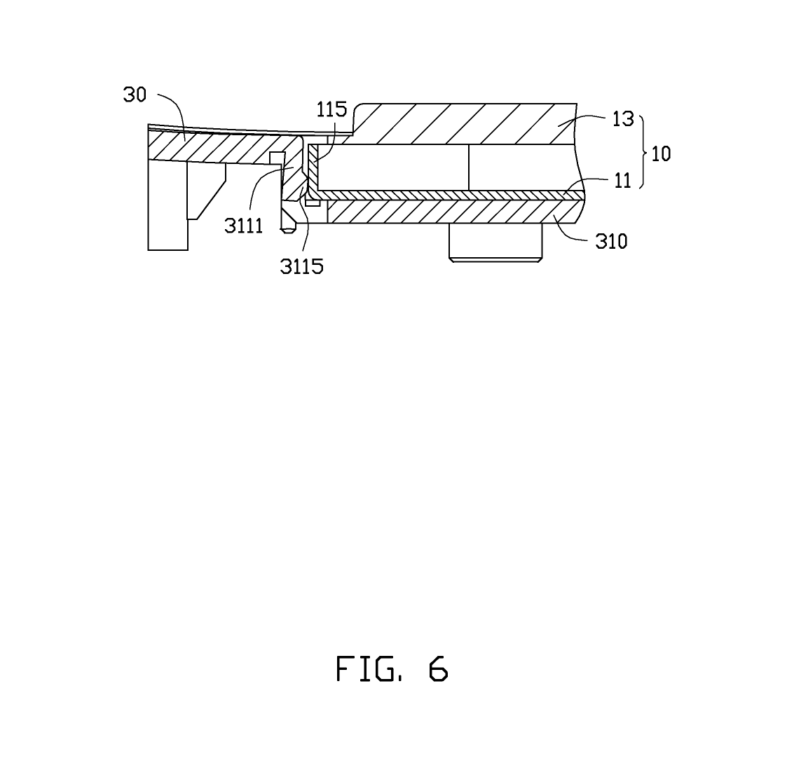

FIGS. 1 and 6 illustrate a mounting apparatus for securing a keyboard 10. The mounting apparatus includes a base 30 and a plurality of latching members 50 secured to the base 30.

The keyboard 10 includes a base board 11 and a plurality of keys 13 located on the base board 11. A first flange 113 extends upwards from a first edge of the base board 11, and a plurality of latch tabs 1111 extends outwards from another edge of the base board 11 opposite to the first edge. Two second flanges 115 extend upwards from opposite edges respectively of the base board 11. In one embodiment, the first flange 113 is substantially perpendicular to the base board 11, and the two second flanges 115 are substantially parallel to each other and are substantially perpendicular to the base board 11. The first flange 113 defines a plurality of cutouts 1131 corresponding to the base 30. Each of the second flanges 115 defines a plurality of engaging holes 1151.

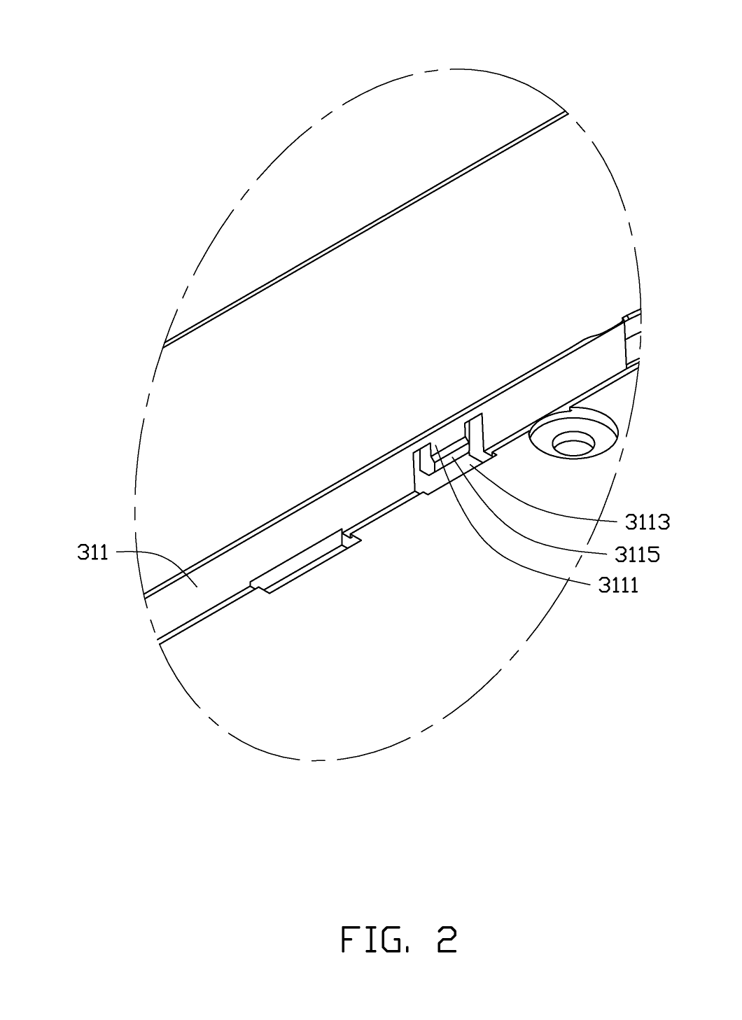

Referring to FIGS. 1 and 2, the base 30 includes a recess portion 31 and a frame 33 integrated with the recess portion 31. The recess portion 31 includes a bottom plate 310, two sidewalls 311, a front wall 313, and a rear wall 315 opposite to the front wall 313. The two sidewalls 311 are parallel to each other and are connected substantially perpendicularly to the bottom plate 310. The front wall 313 and the rear wall 315 are parallel to each other and are connected substantially perpendicularly to the bottom plate 310. Each of the two sidewalls 311 defines two gaps 3113. A blocking arm 3111 is located in each of the two gaps 3113 and extends from one sidewall of each of the two gaps 3113 towards the bottom plate 310. A resisting block 3115 is positioned on a distal end of the blocking arm 3111, located on an inner side of the recess portion 31. The front wall 313 defines a plurality of latching holes 3131 corresponding to the plurality of latch tabs 1111. The rear wall 315 defines a plurality of through holes 3151 corresponding to the plurality of latch members 50.

The frame 33 extends outwards from the rear wall 315. Two positioning posts 331 corresponding to each of the plurality of latch members 50 are located on the frame 33 on two sides of each of the plurality of through holes 3151. Two stopping blocks 333 corresponding to each of the plurality of latch members 50 are located on the frame 33 and are adjacent to the two positioning posts 331 respectively.

Each of the latch members 50 includes a latch portion 51, two resilient arms 53, and two securing rings 55. The latch portion 511 has a guiding slanted surface 511. The two resilient arms 53 are located on two opposites of the latch portion 511. Each of the two securing rings 55 is located on a distal end of each of the two resilient arms 53, respectively.

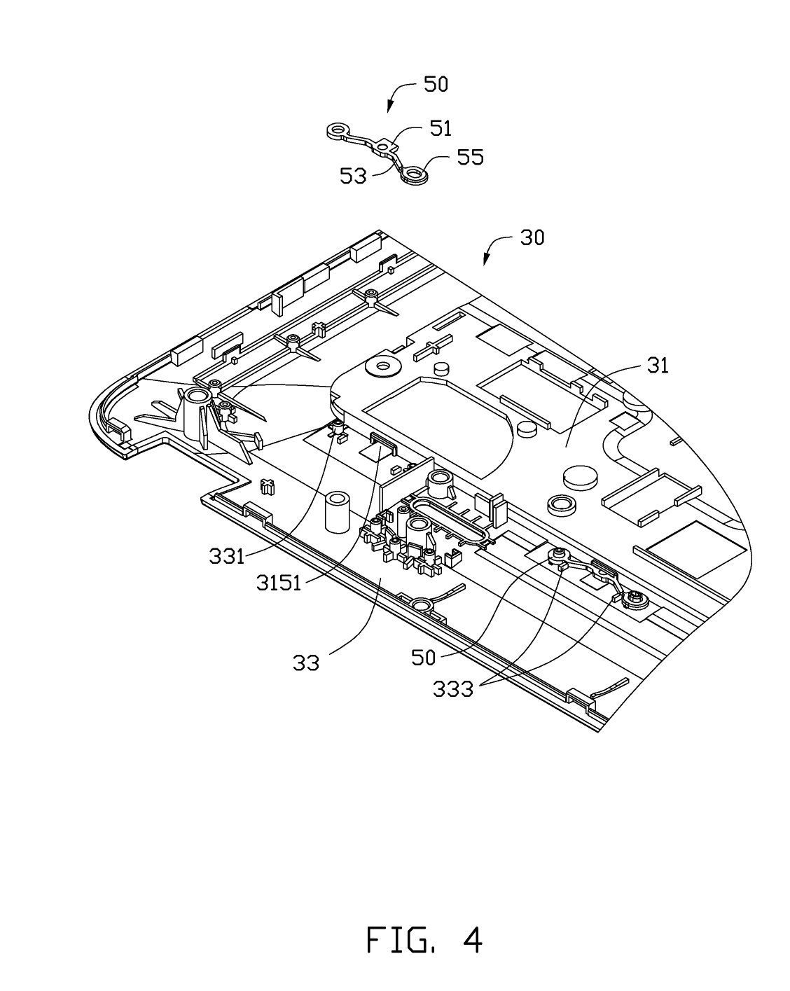

FIG. 4 shows that in assembly the latch portion 511 of each of the plurality of latch members 50 is inserted into each of the plurality of through holes 3151, such that a part of the latch portion 511 is exposed from the rear wall 315. The two securing rings 55 of each of the plurality of latch members 50 respectively surround the two positioning posts 331 and are secured to the base 30 via soldering, riveting, or other method known in the art. Each of the stopping blocks 333 abuts each of the two resilient arms 53 respectively of each of the plurality of latch members 50.

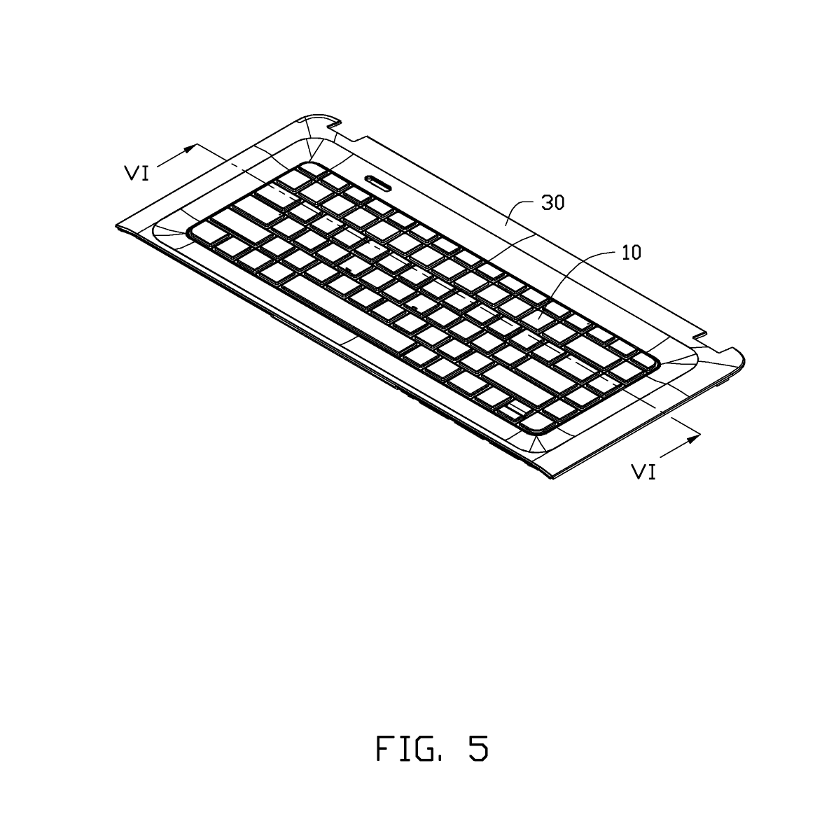

FIGS. 5 and 6 show that in assembly of the keyboard 10, each of the plurality of latch tabs 1111 of the keyboard 10 is engaged into each of the plurality of latch holes 3131, respectively. The keyboard 10 is pressed, and the first flange 113 slides along the guiding slanted surface 511. The first flange 113 pushes the latch portion 51 to move along a first direction to deform the two resilient arms 53, until the latch portion 51 is aligned with the corresponding cutout 1131. The two resilient arms 53 rebound to move the latch portion 51 along a second direction opposite to the first direction to be received in the cutout 1131. Each blocking arm 3111 is resiliently deformable to abut the two second flanges 115 for preventing the keyboard 10 from being moved relative to the recess portion 31.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus comprising:
a base comprising a recess portion and a frame connected to the recess portion, the recess portion being configured to receive a keyboard; and
a plurality of latch members secured to the frame, each of the plurality of latch members comprising a latch portion and two resilient arms located on the latch portion;
wherein the latch portion of each of the plurality of latch members is configured to engage with the keyboard, for preventing the keyboard from disengaging from the recess portion; and the two resilient arms are resiliently deformable to disengage from the keyboard, for releasing the keyboard.

2. The mounting apparatus of claim 1, wherein the recess portion comprises a rear wall, and the rear wall defines a plurality of through holes, and the latch portion of each of the plurality of latch members extends through each of the plurality of through holes, to configured to be engaged with the keyboard.

3. The mounting apparatus of claim 1, wherein two positioning posts are located on the frame, corresponding to each of the plurality of latch members, each of the plurality of latch members further comprises two securing rings, and each of the two securing rings surrounds each of the two positioning posts.

4. The mounting apparatus of claim 3, wherein each of the two securing rings is located on a distal end of each of the two resilient arms.

5. The mounting apparatus of claim 3, wherein two blocking blocks are located on the frame, corresponding to each of plurality of latch members, each of the two blocking blocks is adjacent to each of the positioning posts and abuts each of the two resilient arms of each of the plurality of latch members, to prevent the two resilient arms from over-deformed.

6. The mounting apparatus of claim 1, wherein the recess portion further comprises two sidewalls, each of the two sidewalls defines two gaps, a blocking arm is located in each gap and configured to resiliently abut two opposite sides of the keyboard, for preventing the keyboard from movable relative to the recess portion.

7. The mounting apparatus of claim 6, wherein a resisting block is located on a distal end of the blocking arm, and the resisting block abuts the keyboard.

8. The mounting apparatus of claim 6, wherein each blocking arm extends from a sidewall of each gap towards to another sidewall.

9. The mounting apparatus of claim 1, wherein the latch portion comprises a guiding slanted surface, for guiding the keyboard.

10. An assembly comprising:
a keyboard,
a base comprising a recess portion and a frame connected to the recess portion, the recess portion receiving the keyboard, and
a plurality of latch members secured to the frame, each of the plurality of latch members comprising a latch portion and two resilient arms located on the latch portion; the latch portion of each of the plurality of latch members is engaged with the keyboard, for preventing the keyboard from disengaging from the recess portion; and the two resilient arms are resiliently deformable to disengage from the keyboard, for releasing the keyboard.

11. The assembly of claim 10, wherein the recess portion comprises a rear wall, and the rear wall defines a plurality of through holes, and the latch portion of each of the plurality of latch members extends through each of the plurality of through holes and is engaged with the keyboard.

12. The assembly of claim 10, wherein two positioning posts are located on the frame, corresponding to each of the plurality of latch members, each of the plurality of latch members further comprises two securing rings, and each of the two securing rings surrounds each of the two positioning posts.

13. The assembly of claim 12, wherein each of the two securing rings is located on a distal end of each of the two resilient arms.

14. The assembly of claim 12, wherein two blocking blocks are located on the frame, corresponding to each of plurality of latch members, each of the two blocking blocks is adjacent to each of the positioning posts and abuts each of the two resilient arms of each of the plurality of latch members, to prevent the two resilient arms from over-deformed.

15. The assembly of claim 10, wherein the recess portion further comprises two sidewalls, each of the two sidewalls defines two gaps, a blocking arm is located in each gap and configured to resiliently abut two opposite sides of the keyboard, for preventing the keyboard from movable relative to the recess portion.

16. The assembly of claim 15, wherein a resisting block is located on a distal end of the blocking arm, and the resisting block abuts the keyboard.

17. The assembly of claim 15, wherein each blocking arm extend from a sidewall of each gap towards to another sidewall.

18. The assembly of claim 10, wherein the latch portion comprises a guiding slanted surface, for guiding the keyboard.

19. The assembly of claim 11, wherein the recess portion further comprises a front wall opposite to the rear wall defining a plurality of latch holes, the keyboard comprises a plurality of latch tabs, and each of the plurality of latch tabs is engaged in each of the plurality of latch holes.
